(19) United States
(12) Patent Application Publication
(10) Pub. No.: US 2017/0207671 A1
(43) Pub. Date: Jul. 20, 2017

(54) ROTOR FOR AN ELECTRIC MOTOR

(71) Applicant: ThyssenKrupp Presta TecCenter AG, Eschen (LI)

(72) Inventors: Daniel Paul, Burkhardtsdorf (DE); Juergen Meusel, Dittmannsdorf (DE)

(73) Assignee: ThyssenKrupp Presta TecCenter AG, Eschen (LI)

(21) Appl. No.: 15/328,841

(22) PCT Filed: Jul. 1, 2015
(86) PCT No.: PCT/EP2015/064926

§ 371 Date: Jan. 24, 2017

(30) Foreign Application Priority Data
Jul. 24, 2014 (DE) 10 2014 110 439.0

(51) Int. Cl. H02K 1/28

(52) U.S. Cl. CPC H02K 1/28

(57) ABSTRACT

A rotor for an electric motor may include a shaft and a plurality of disks that are received on the shaft. The disks may include an inner passage, through which the shaft is guided, with the result being that the disks are centered on the shaft via the inner passage. The plurality of disks may have spring tongues that are configured in or along the inner passage and are braced with a bracing force in a circumferential direction against at least one mating geometry that is configured on the shaft.”

The present invention relates to a rotor for an electric motor having a shaft and having a plurality of disks which are received on the shaft, and the disks having an inner passage, through which the shaft is guided, with the result that the disks are centered on the shaft via the inner passage. Furthermore, the invention is directed to an electric motor having a rotor of this type.

### PRIOR ART

DE 84 28 517 U1 has disclosed a method according to what is known as punch bundling, in order to produce a rotor of this type for an electric motor from metal sheets which are stacked on one another and will be called disks in the following text. The rotor has sheet metal disks which are applied in a pack arrangement on a shaft and are connected to the latter in a torque-proof manner. For this purpose, the disks have an inner passage, through which the shaft of the rotor is guided, with the result that the disks are centered on the shaft. The inner passage has a plurality of regions in discrete circumferential sections, by way of which the inner passage is defined, and the regions are configured as sprung tongues. When the shaft is pushed through the inner passage of the disks, the tongues deflect in the axial direction and can fix the disks on the shaft. Here, however, great torques cannot be transmitted between the disks and the shaft; rather, the elastic, sprung tongues serve to compensate for tolerances, and the shaft can be pressed into the disks, without there being the risk of metallic jamming, that is to say “fretting”.

DE 10 2008 004 876 A1 teaches a further embodiment of a rotor having a shaft and a plurality of disks which are applied on the shaft, and the possibility of pushing the disks onto the shaft is shown by way of one exemplary embodiment, sprung projections of the disks which protrude into the inner passage of the disks deforming elastically in the axial direction and producing notches on the surface of the shaft. In this way, a positively locking connection which is at least very small is also produced in the circumferential direction between the elastic projections of the disks and the shaft, it not being possible, however, for great torques to be transmitted.

Furthermore, the possibility is mentioned that the fastening of the disks on the shaft can be carried out by way of a cylindrical interference fit, but an interference fit with narrow tolerances requires great machining complexity, with the result that high manufacturing costs arise.

Furthermore, DE 10 2008 004 876 A1 recommends that the shaft has a recess, into which the sprung projection of the disk of the disk pack engages partially, with the result that the positively locking connection is formed in the circumferential direction between the disks and the shaft. This is intended to make an inexpensive embodiment of the positively locking connection possible, but a play-free transmission of, in particular, alternating torques can likewise not be produced in this way, since elastic bracing is produced only in the axial direction.

### DISCLOSURE OF THE INVENTION

It is an object of the invention to develop a connection between a shaft and disks which are applied on the shaft in order to form a rotor for an electric motor; a torque-transmitting, in particular rigid connection between the disks and the shaft is to be achieved. Here, in particular, narrow tolerances are to be avoided, in order to keep the manufacturing costs of the rotor which is formed in this way low.

Said object is achieved proceeding from a rotor for an electric motor in accordance with the preamble of claim 1 in conjunction with the characterizing features. Advantageous developments of the invention are specified in the dependent claims.

The invention includes the technical teaching that the disks have spring tongues which are configured in the inner passage and are braced with a bracing force in the circumferential direction against at least one mating geometry which is configured on the shaft.

Bracing according to the invention of the spring tongues in the circumferential direction achieves the advantage that a non-positive connection is superimposed on the positively locking connection which is formed in this way, with the result that the positively locking connection serves to transmit very great torques between the shaft and the disks, and the bracing of the spring tongues on the mating geometry makes bracing of the disks on the shaft in a play-free manner in the circumferential direction possible. The connection between the shaft and the disks is not eliminated even in the case of alternating loading in the circumferential direction, for example in the case of torques to be transmitted having changing directions or in the case of torsional vibrations which occur. By virtue of the fact that a plurality of disks but not necessarily all disks preferably have spring tongues, great torques can be transmitted via the multiplicity of spring tongues. In particular, highly fixed bracing of the disks on the shaft in a manner which acts in the circumferential direction is brought about.

The disks can be applied on the shaft individually, in a common punch bundled arrangement or in a plurality of punch bundled units, the plurality of disks and particularly preferably all disks preferably being configured so as to protrude with spring tongues into their inner passage.

The spring tongues can particularly advantageously be configured in pairs on the disks and can be bent toward one another or away from one another during the build-up of the bracing force against the mating geometry. The bracing force is then introduced into the spring tongues when the disks are pushed onto the shaft. Here, the disks pass into contact with the mating geometry and are bent accordingly, the bending of the spring tongues preferably taking place elastically or at least predominantly elastically and possibly with plastic deformation.

According to a first preferred design variant, the mating geometry can be formed by way of a groove in the outer circumferential face of the shaft. Here, in the circumferential position, the spring tongues can protrude into the inner passage, to be precise the position of the spring tongues can be selected in such a way that it coincides with the groove in the shaft. For example, four spring tongues which are arranged, in particular, in pairs can be configured distributed over the circumference in discrete positions on the circumference and can protrude into the inner passage, the shaft having four grooves on the outer circumference. When the disks are pushed onto the shaft, the circumferential positions of the spring tongues have to coincide with the circumferential positions of the grooves, with the result that the spring tongues can be braced against the grooves.

In particular, when the disks are arranged on the shaft, the spring tongues can engage into the groove and can be braced in pairs against the side flanks of the groove. If the disks are seated in the grooves, the disks can be centered on the shaft via the diameter of the inner passage. If the spring tongues protrude into the groove or into the grooves of the shaft here, the spring tongues can be braced against the opposite side flanks of the groove. As a result of the configuration of the spring tongues in pairs, two spring tongues can lie opposite one another, and, during the engagement into the groove, the spring tongues are bent, for example, in such a way that they move toward one another, for example, under elastic deformation. The spring tongues are therefore spread in the groove of the shaft, and a plurality of pairs of spring tongues can engage into respectively associated grooves in a manner which is distributed over the circumference.

According to a further advantageous design variant, the mating geometry can also be formed by way of a driver profile which is seated on the outer circumferential face of the shaft. For example, the driver profile can be configured as a type of feather key, with the result that the driver profile extends radially beyond the outer circumferential face of the shaft. In the circumferential position, the spring tongues can be configured so as to be set back in the contour of the inner passage, and, when the disks are pushed onto the shaft, the at least one driver profile on the shaft can engage into the region of the spring tongues which are set back.

When the disks are arranged on the shaft, the driver profile can therefore be seated between two spring tongues, with the result that the spring tongues are braced in pairs against the side flanks of the driver profile. In particular, the spring tongues which are arranged in pairs are bent away from one another, with the result that they are spread open as a consequence.

During the build-up of the bracing force of the spring tongues against the mating geometry, the spring tongues on the disk can spring back elastically or at least predominantly elastically in the circumferential direction. There can also be provision, however, to dimension the mating geometry in such a way that the spring tongues pass through an elastic region and also have a plastic deformation region when the disks are pushed onto the shaft.

According to one preferred refinement of the spring tongues on the disk, said spring tongues can be configured in a bracket-like or tooth-like or prong-like manner. For example, the spring tongue can taper toward its tip, and/or can have a smaller thickness toward its tip.

The arrangement of the spring tongues in pairs is determined by the fact that a first spring tongue springs back in a first circumferential direction and a further spring tongue which is assigned to the first spring tongue springs back in an opposite circumferential direction. Here, the spring tongues which are arranged in pairs do not necessarily have to be arranged next to one another on the inner circumference of the inner passage, and the pairs of the spring tongues can also overlap.

In particular, a cutout can be configured between the spring tongues which are arranged in pairs on the disk if they form adjacent spring pairs, with the result that an enlarged elastic deformation region of the spring tongues is formed by way of the cutout. It is a further advantage that cutouts can also be configured on the rear side of the spring tongues which are arranged in pairs on the disk, with the result that the spring tongues have a longer elastic region via a root which lies deeper as a result of the cutouts. As a result, the spring elasticity of the spring tongues on the contour of the inner passage of the disks can be increased.

When the disks are pushed onto the shaft, they first of all have to be threaded onto the latter via one end of the shaft. For this purpose, the groove which can form the mating geometry on the shaft according to the first design variant can have, on the end side, an insertion section which is of broader configuration in the circumferential direction than the groove, and the insertion section can taper as far as the transition into the groove. As a result, pushing the disks onto the shaft is facilitated, and the spring tongues can slide into the insertion section and can be deformed continuously over said insertion section. In particular, the spring tongues can be bent toward one another or away from one another in pairs over the insertion section.

If the mating geometry is configured as a driver profile, this can likewise have an end-side insertion section in a comparable way and with a comparable function, which insertion section is of narrower configuration in the circumferential direction than the driver profile itself, and said insertion section can merge in a widening manner into the driver profile.

The insertion sections at the end of the groove or at the end of the driver profile lead to the advantage that no tool is required for the deformation of the spring tongues in the circumferential direction. The spring tongues do not need to first of all be compressed or pressed apart from one another with a tool by way of the insertion sections, in order that they can be threaded into the groove or onto the driver profile.

Furthermore, the invention is directed to an electric motor with a rotor, having a shaft and a plurality of disks which are received on the shaft, and the disks having an inner passage, through which the shaft is guided, with the result that the disks are centered on the shaft via the inner passage. According to the invention, the disks have spring tongues which are configured in the inner passage and are braced with a bracing force in the circumferential direction against at least one mating geometry which is configured on the shaft.

### PREFERRED DESIGN VARIANTS OF THE INVENTION

Further measures which improve the invention will be shown in greater detail in the following text together with the description of one preferred exemplary embodiment of the invention using the figures, in which:

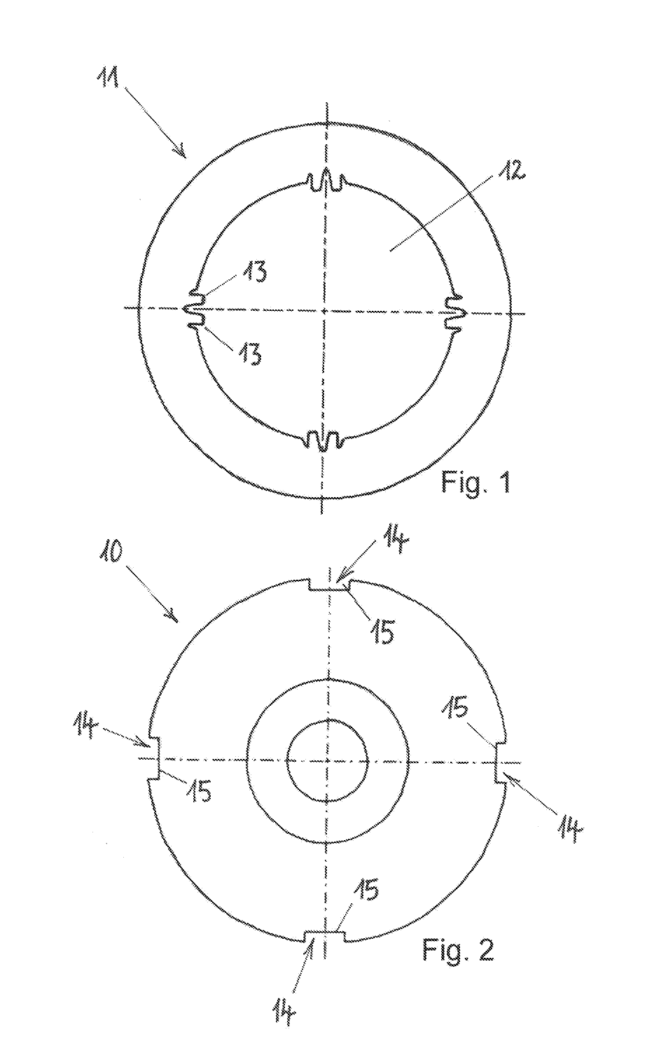

FIG. 1 shows a view of a disk having spring tongues which are configured according to the invention and protrude into the inner passage of the disk,

FIG. 2 shows a shaft having a mating geometry which is configured in the form of a groove, with the result that the disk which is shown in FIG. 1 can be pushed onto the shaft which is configured with grooves,

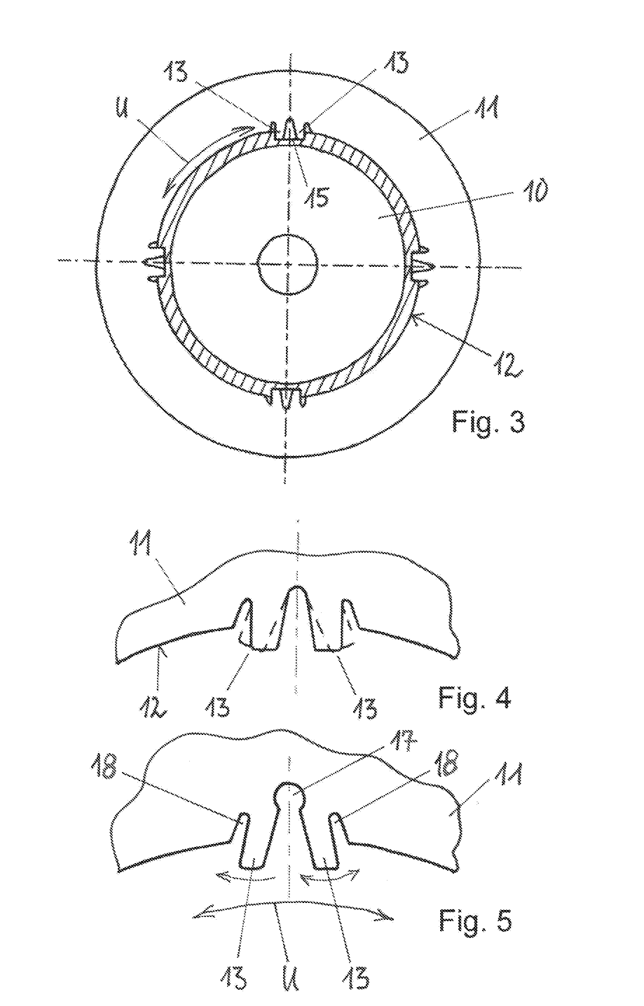

FIG. 3 shows a view of a disk according to FIG. 1 in an arrangement on a shaft according to FIG. 2,

FIG. 4 shows a detailed view of spring tongues which are arranged in pairs in the inner passage of a disk in a non-bent state and in a bent state,

FIG. 5 shows a further design variant of spring tongues which are arranged in pairs in the inner passage of a disk having cutouts,

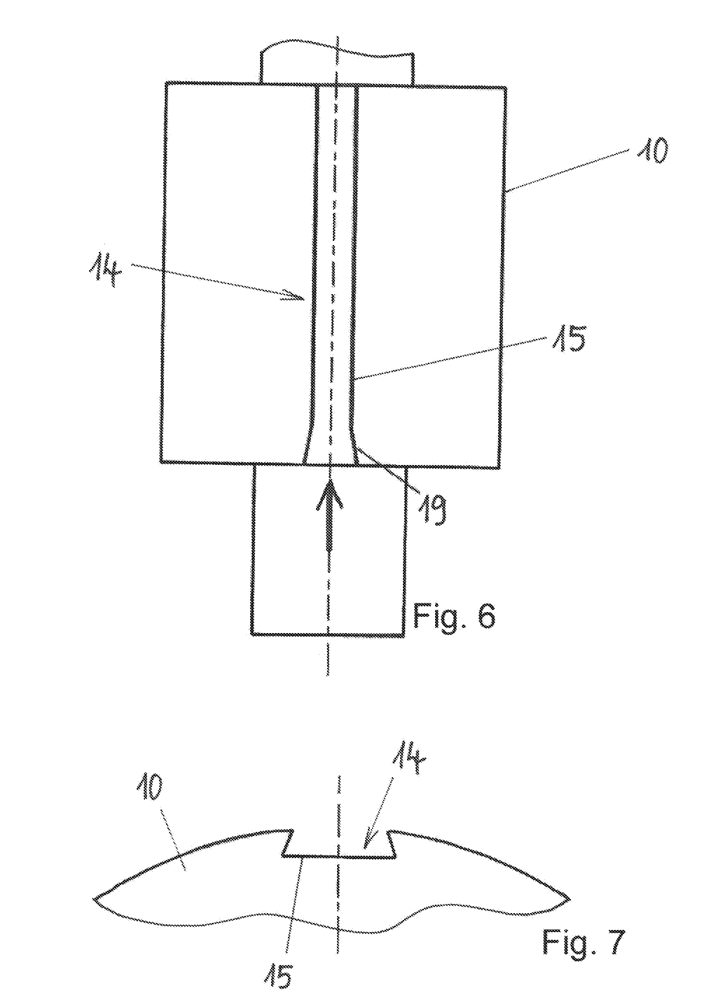

FIG. 6 shows a view of a shaft having a groove which has an insertion section in the end region,

FIG. 7 shows a further refinement of a groove in the manner of a dovetail guide,

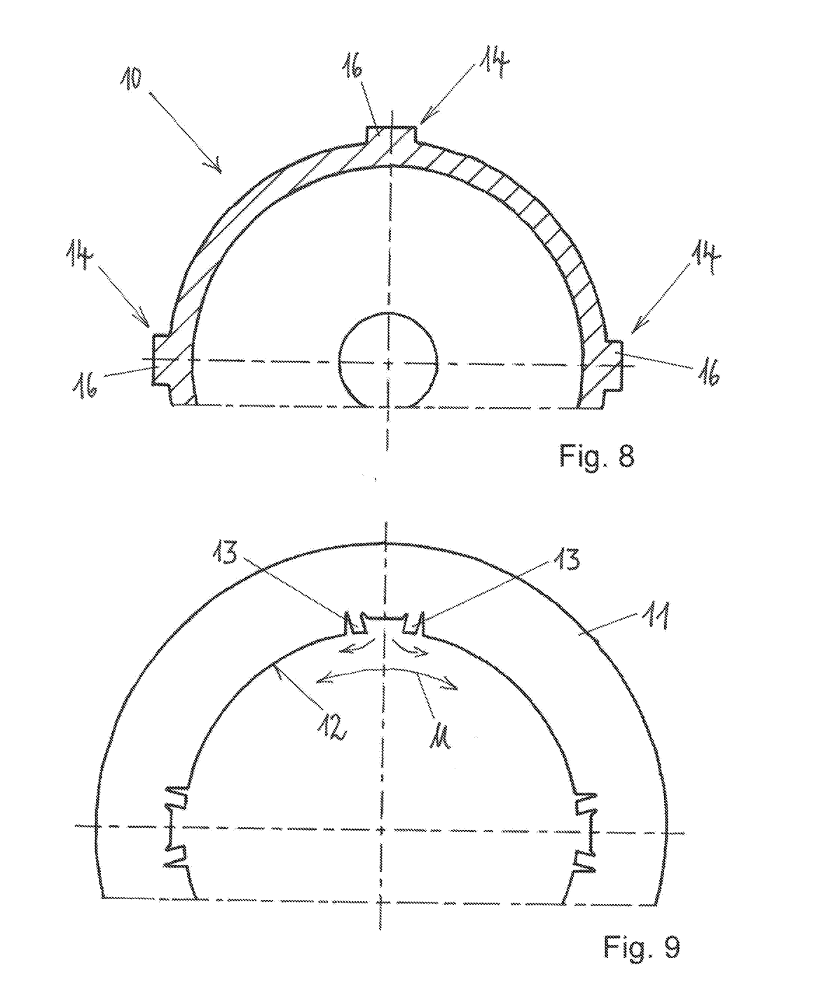

FIG. 8 shows a further design variant of a shaft having mating geometries which are configured in the manner of a driver profile,

FIG. 9 shows a disk having spring tongues which are configured so as to be set back in the inner passage of the disk,

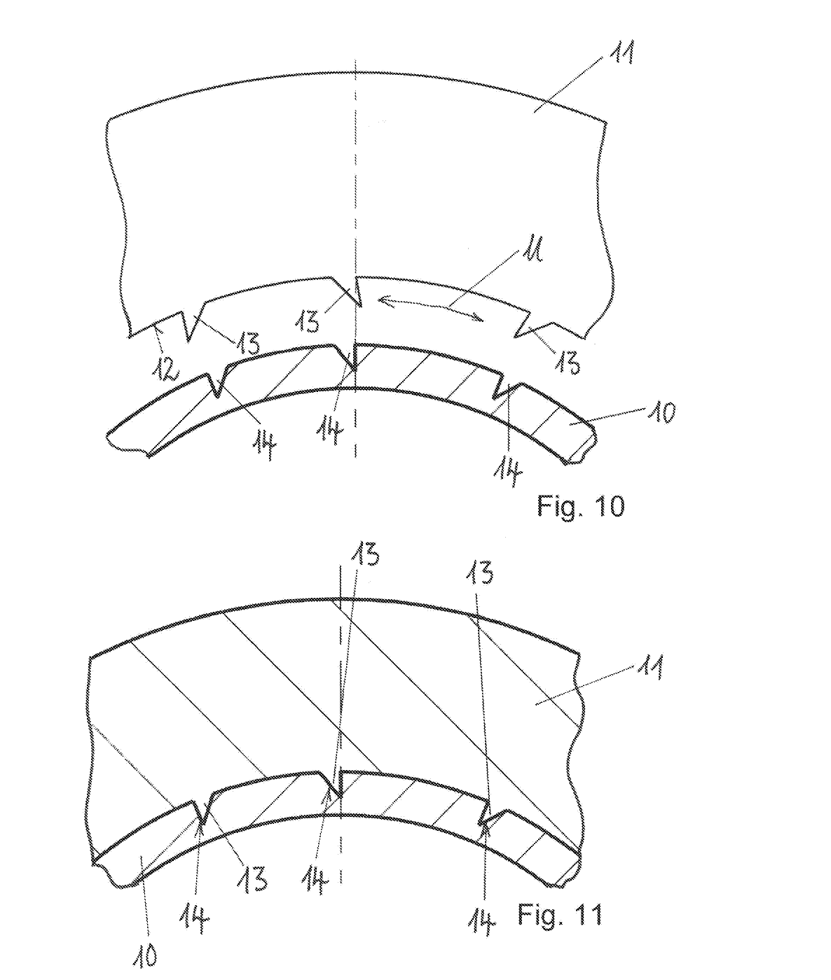

FIG. 10 shows a further design variant of a disk and a shaft in an illustration of details, the spring tongues being configured alternately in a first and in a second circumferential direction, and

FIG. 11 shows the design variant of the disk according to FIG. 10 in an arrangement on a shaft according to FIG. 10.

FIG. 1 shows a side view of a disk 11 which is configured with an inner passage 12. The disk 11 can be configured from a thin metal sheet, and a plurality of disks 11 can be provided on a shaft 10 in order to form a rotor for an electric motor.

A plurality of spring tongues 13 are configured in the inner contour of the inner passage 12. The spring tongues 13 protrude into the inner passage 12 and therefore project beyond the inner contour. The spring tongues 13 are configured in pairs at discrete circumferential positions in the inner contour of the inner passage 12, and the example shows four circumferential positions, at which there are in each case two spring tongues 13.

FIG. 2 shows a shaft 10 which is shown from the direction of its shaft axis. Four mating geometries 14 which are configured as grooves 15 are made in the shaft. The grooves 15 have a substantially rectangular cross section and run in an axially parallel manner with respect to the axis of the shaft 10. Therefore, the disks 11 according to FIG. 1 can be pushed onto the shaft 10 from the direction of the shaft axis, with the result that the arrangement of the disks 11 on the shaft 10 according to FIG. 3 can be formed.

As shown in FIG. 3, when the disks 11 are pushed onto the shaft 10, the disks 11 are centered via their inner passage 12 on the outer circumference of the shaft 10. At the same time, the spring tongues 13 can engage into the grooves 15 in such a way that the spring tongues 13 are bent toward one another under elastic springback. As a result, the spring tongues lie against the inner side flanks of the groove 15 and are braced in the latter. The springback of the spring tongues 13 in their arrangement in pairs takes place in such a way that the spring tongues 13 and therefore the disk 11 are braced on the shaft 10 in the circumferential direction U and thus form a positively locking connection which is superimposed in the circumferential direction with a non-positive connection. As a result, the disk 11 can be applied on the shaft 10 in a manner which is centered via its inner passage 12, a transmission of torques in alternating directions between the disk 11 and the shaft 10 without reversal play becoming possible at the same time.

FIG. 4 shows spring tongues 13 in the inner contour of an inner passage 12 of a disk 11. Here, the spring tongues 13 are shown loaded by way of a solidly drawn contour and are therefore bent toward one another, and, in the contour which is shown using a dashed line, the spring tongues 13 are shown in an unloaded arrangement which is produced when the disk 11 is not pushed onto the shaft 10. It becomes clear from the illustration that, according to FIG. 3, the spring tongues 13 are bent toward one another in pairs when the spring tongues 13 are situated in the groove 15 and lie against the side flanks of the groove 15.

FIG. 5 shows a configuration of spring tongues 13 in a modified form, a cutout 17 being situated between the spring tongues 13 which are arranged in pairs. Cutouts 18 are situated on the rear side of the spring tongues 13 which are arranged on the disk 11 in pairs. The spring-elastic arrangement of the spring tongues 13 on the disk 11 is improved by way of the cutouts 17 and 18, with the result that said spring tongues 13 have an enlarged spring-elastic region. The spring-elastic mobility of the spring tongues 13 is shown in relation to the circumferential direction U by way of double arrows.

FIG. 6 shows a shaft 10 of a rotor for an electric motor having a groove 15 for forming the mating geometry 14. On one end side, the groove 15 has an insertion section 19, and the disks 11 can be pushed onto the shaft 10 via the insertion section 19, the pushing-on direction of the disks 11 being indicated by way of an arrow. When the disks 11 are pushed on, the spring tongues 13 can be threaded via the insertion section 19 into the groove 15. For this purpose, the insertion section 19 has a width which tapers in the direction of the groove 15. When passing through the insertion section 19, the spring tongues 13 are moved toward one another, with the result that they change into a position, as shown by way of the position of the spring tongues 13 shown using dashed lines in FIG. 4 in a manner changing into the contour of the spring tongues 13 shown using solid lines.

FIG. 7 shows the configuration of a mating geometry 15 in the outer circumferential face in the shaft 10, and the mating geometry 15 is shown as a slightly modified groove 15 with a dovetail contour. As a result of the dovetail contour, an improved positively locking connection can be achieved between the spring tongues 13 and the groove 15 when said spring tongues 13 are seated in the groove 15.

FIG. 8 shows a further design variant of the shaft 10 having mating geometries 14 which are configured as driver profiles 16. When a disk 11 according to FIG. 9 which is configured with spring tongues 13 which are arranged in pairs and point in a manner which is set back in the direction of the inner passage 12 is pushed onto the shaft 10 according to the design variant from FIG. 8, the spring tongues 13 are bent toward one another, as shown by way of the two arrows in FIG. 9. If the disk 11 is seated on the shaft 10 in a manner which is centered via its inner passage 12, the spring tongues 13 surround the projecting driver profile 16, and the spring tongues 13 press against the side flanks of the driver profile 16 under spring-elastic prestress. As a result, the disk 11 is braced on the shaft 10 in the circumferential direction U.

The insertion section 19 which is described in conjunction with the first exemplary embodiment according to FIG. 6 can also be provided in the variant of the mating geometry 14, as shown in FIG. 8, and the driver profile 16 can likewise have an end-side insertion section in a manner which is not shown in greater detail.

Finally, FIG. 10 also shows a further design variant for arranging a disk 11 on a shaft 10, the spring tongues 13 being configured in a prong-like manner, and adjacent spring tongues 13 which protrude into the inner passage 12 of the disk 11 pointing alternately in opposite directions. The shaft 10 is shown with mating geometries 14 which are adapted to the spring tongues 13 which are configured in a prong-like manner, the spring tongues 13 engaging into the mating geometries 14 with slight springback when the disk 11 is pushed onto the shaft 10, as shown in FIG. 11.

The exemplary embodiment according to FIGS. 10 and 11 shows a variant, according to which the spring tongues 13 which are bent in pairs and are braced with or against one another are configured in a manner which is not adjacent to one another at a discrete circumferential position on the inner passage 12 of the disk 11.

The springback of the spring tongues 13 in the circumferential direction U produces a countertorque of the disk 11 about the center axis of the shaft 10, with the result that at least one further spring tongue 13 has to spring back in an opposite direction. Thus, for example, the outer spring tongues 13 which are shown can be braced against one another, the centrally shown spring tongue engaging into the mating geometry 14 on the shaft 10 and producing a torque equalization with a further spring tongue 13 (not shown) when the disk 11 is pushed onto the shaft 10.

### LIST OF DESIGNATIONS

10 Shaft
11 Disk
12 Inner passage
13 Spring tongue
14 Mating geometry
15 Groove
16 Driver profile
17 Cutout
18 Cutout
19 Insertion section
U Circumferential direction

1.-12. (canceled)

13. A rotor for an electric motor comprising:
a shaft; and
a plurality of disks that are received on the shaft, wherein the plurality of disks include an inner passage through which the shaft is guided, which results in the plurality of disks being centered on the shaft via the inner passage, wherein the plurality of disks have spring tongues that are configured in or along the inner passage and are braced with a bracing force in a circumferential direction against at least one mating geometry that is configured on the shaft, wherein the bracing force is introduced into the spring tongues when the plurality of disks are pushed onto the shaft.

14. The rotor of claim 13 wherein the spring tongues are configured in pairs on the plurality of disks and are bent toward one another or away from one another during a build-up of the bracing force against the at least one mating geometry.

15. The rotor of claim 13 wherein the at least one mating geometry is formed by way of a groove in an outer circumferential face of the shaft.

16. The rotor of claim 15 wherein in a circumferential position the spring tongues protrude into the inner passage in which the groove in the shaft is configured.

17. The rotor of claim 15 wherein when the plurality of disks are disposed on the shaft, the spring tongues engage into the groove and are braced in pairs against side flanks of the groove.

18. The rotor of claim 13 wherein the at least one mating geometry is formed by way of a driver profile that is seated on an outer circumferential face of the shaft.

19. The rotor of claim 18 wherein in a circumferential position the spring tongues are configured so as to be set back in a contour of the inner passage in which the driver profile is seated on the shaft.

20. The rotor of claim 18 wherein when the plurality of disks are disposed on the shaft, the driver profile is seated between two of the spring tongues such that the two spring tongues are braced in a pair against side flanks of the driver profile.

21. The rotor of claim 13 wherein during a build-up of the bracing force of the spring tongues against the at least one mating geometry, the spring tongues on the plurality of disks spring back elastically in the circumferential direction.

22. The rotor of claim 13 further comprising at least one of:
a cutout disposed between the spring tongues, which are arranged in pairs on the plurality of disks; or
a cutout disposed on a rear side of the spring tongues, which are arranged in pairs on the plurality of disks.

23. The rotor of claim 13 wherein the at least one mating geometry is formed by way of a groove in the outer circumferential face of the shaft or by way of a driver profile that is seated on the outer circumferential face of the shaft, wherein
on an end side the groove has an insertion section that is of a broader configuration in the circumferential direction than the groove and that merges in a tapering manner into the groove; or
the driver profile includes an insertion section that is of narrower configuration in the circumferential direction than the driver profile and that merges in a widening manner into the driver profile.

24. An electric motor including a rotor that comprises:
a shaft; and
a plurality of disks that are received on the shaft, the plurality of disks including an inner passage through which the shaft is guided, resulting in the plurality of disks being centered on the shaft via the inner passage, wherein the plurality of disks have spring tongues that are configured in or along the inner passage and are braced with a bracing force, which is introduced into the spring tongues when the disks are pushed onto the shaft, in a circumferential direction against at least one mating geometry that is configured on the shaft.

25. A rotor for an electric motor comprising:
a plurality of disks that include an inner passage and spring tongues disposed in or along the inner passage; and
a shaft that extends through and supports the plurality of disks, wherein the inner passage of the plurality of disks centers the plurality of disks on the shaft, wherein the shaft includes a mating geometry that engages with the spring tongues of the plurality of disks and braces the spring tongues by exerting a bracing force in a circumferential direction.

26. The rotor of claim 25 wherein the spring tongues are configured in pairs on the plurality of disks and are bent toward one another or away from one another.

27. The rotor of claim 25 wherein the mating geometry comprises a groove in an outer circumferential face of the shaft.

28. The rotor of claim 27 wherein in a circumferential position the spring tongues protrude into the inner passage in which the groove in the shaft is configured.

29. The rotor of claim 27 wherein the spring tongues engage into the groove and are braced in pairs against side flanks of the groove.

30. The rotor of claim 25 wherein the mating geometry is formed by way of a driver profile that is seated on an outer circumferential face of the shaft.

31. The rotor of claim 30 wherein in a circumferential position the spring tongues are configured so as to be set back in a contour of the inner passage in which the driver profile is seated on the shaft.

32. The rotor of claim 30 wherein the driver profile is seated between two of the spring tongues such that the two spring tongues are braced in a pair against side flanks of the driver profile.
